(19) United States
(12) Patent Application Publication
(10) Pub. No.: US 2011/0260436 A1
(43) Pub. Date: Oct. 27, 2011

(54) PASSENGER AIRBAG APPARATUS

(76) Inventors: Hae Kwon PARK, Cheongju-si (KR); Gun Woo Kim, Seongnam-si (KR); Min Seok Koh, Yongin-si (KR)

(21) Appl. No.: 13/039,203

(22) Filed: Mar. 2, 2011

(30) Foreign Application Priority Data
Apr. 27, 2010 (KR) 10-2010-0038939
Apr. 27, 2010 (KR) 10-2010-0038940
May 6, 2010 (KR) 10-2010-0042613

(51) Int. Cl. B60R 21/16

(52) U.S. Cl. 280/735

(57) ABSTRACT

Provided is a passenger airbag apparatus that not only allows an airbag cushion to inflate in different sizes, depending on the types and positions of passengers in a passenger seat, but can automate a folding process, because the airbag cushion is made in 2D.

The passenger airbag apparatus according to an exemplary embodiment of the present invention includes: a passenger sensor detecting information on the type and position of a passenger in a passenger seat; a controller outputting control signal on the basis of the information supplied from the passenger sensor; a gas generator generating different amounts of gas in response to the control signal transmitted from the controller; and an airbag cushion connected with the gas generator, having a folded portion that is folded and bound, and inflating in different sizes while the folded portion is unfolded in accordance with the amounts of gas supplied from the gas generator.

### CROSS-REFERENCE TO RELATED APPLICATIONS

The present application claims priority to Korean Patent Application Number 10-2010-0038939, 10-2010-0038940 and 10-2010-0042613 filed Apr. 27, 2010, Apr. 27, 2010 and May 6, 2010, the entire contents of which application is incorporated herein for all purposes by this reference.

### BACKGROUND OF THE INVENTION

1. Field of the Invention

The present invention relates to a passenger airbag apparatus, and more particularly, to a passenger airbag apparatus having an airbag cushion with folded portions that are unfolded by the amount of gas supplied from a gas generator, in which the airbag cushion is formed by two panels.

2. Description of the Related Art

In general, vehicles are equipped with airbag systems that prevent passengers from directly hitting against the structure of the vehicles and being hurt by unfolding between the structure of the vehicles and the passengers in a vehicle collision.

These airbag systems are classified into a driver's airbag system that is mounted in the steering wheel in front of the driver's seat, a passenger airbag system that is mounted at in the upper portion of the glove box in front of the passenger's seat, a curtain airbag system that is mounted along the roof rail and unfolds between the door and a passenger, and a side airbag system that is mounted in a seat, the console box, or the arm rest of a door and unfolds to the passenger's side.

Those airbag systems are operated by an ACU (Airbag Control Unit) that controls an inflator that is a gas generator in response to a signal detected by a sensor that senses a vehicle accident. That is, as a gas generating unit explodes and generates a gas in the inflator by means of a control order from the ACU, the gas flows into the airbag cushion connected with the inflator and the airbag cushion is correspondingly unfolded and inflated by the pressure of the gas flowing into the airbag cushion, thereby protecting a passenger.

The airbag cushion, however, is generally designed to unfold under an unfolding pressure based on common adults in consideration of the common adults' body conditions.

However, not only common adult, but infants or children or adults with poor body conditions, even if they are adults, may sit in the passenger seat. Therefore, when infants, children, or adults with poor body conditions sit in the passenger seat, they may rather be hurt by the unfolding pressure of the airbag cushion.

Further, the airbag cushion also fails to protect the passenger in the passenger seat under the designed folding pressure, when the passenger abnormally sits in the passenger seat, for example, at the front portion of the passenger seat or at the rear portion of the passenger seat, which is called OOP (Out-Of-Position sitting) in the art.

Therefore, passenger airbag apparatuses of which the airbag cushions have different folding pressures that are applied to passengers in accordance with the types and positions of the passengers in the passenger seat are required.

Meanwhile, although the airbag cushions are generally manufactured in 2D by sewing two panels, the passenger airbag cushions are manufactured in 3D by sewing three panels to protect infants, children, and adults with poor body conditions, in addition to common adults. That is, since the portions of the passengers which contact with the passenger airbag cushions are different in accordance with the types of passengers in the passenger seat, the passenger airbag cushions are made in 3D and the structures of specific portions contacting with the passengers are changed in accordance with the types of passengers such that different unfolding pressures are applied to the passengers from the airbag cushions.

However, the 3D passenger airbag cushions have a problem that the folding process of folding the airbag cushions to be inserted in the airbag housings is made by hand. That is, the other airbag cushions, except for the passenger airbag cushions, are composed of two panels in flat 2D, such that they are automatically folded by a machine, whereas the passenger airbag cushions manufactured in 3D have been folded by hand.

Therefore, it is required to develop a passenger airbag cushion that is composed of two panels to automatically fold.

### SUMMARY OF THE INVENTION

The present invention has been made in effort to provide a passenger airbag cushion that allows an airbag cushion to inflate in different sizes, depending on the types and positions of passengers in a passenger seat.

Further, the present invention has been made in effort to provide a passenger airbag apparatus that can automate a folding process by making the airbag cushion flat in 2D (dimension).

The objects of the present invention are not limited to the object described above, and the other objects not stated in the above will be clearly understood by those skilled in the art from the following description.

An exemplary embodiment of the present invention provides a passenger airbag apparatus including: a passenger sensor detecting information on the type and position of a passenger in a passenger seat; a controller outputting control signal on the basis of the information supplied from the passenger sensor; a gas generator generating different amounts of gas in response to the control signal transmitted from the controller; and an airbag cushion connected with the gas generator, having a folded portion that is folded and bound, and inflating in different sizes while the folded portion is unfolded in accordance with the amounts of gas supplied from the gas generator.

The details of other exemplary embodiments are included in the detailed description and the drawings.

According to exemplary embodiments of the present invention, it is possible to allow an airbag cushion to inflate in different sizes, depending on the types and positions of passengers in a passenger seat, because a folded portion that is folded in accordance with the amount of gas supplied from a gas generator is formed in the airbag cushion.

Further, since the airbag cushion is composed of two panels combined flat, a folding process can be automated.

The effects of the present invention are not limited to the effects described above, and the other effects not stated in the above will be clearly understood by those skilled in the art from the following description.

### BRIEF DESCRIPTION OF THE DRAWINGS

FIG. 1 is a block diagram of a passenger airbag apparatus according to a first exemplary embodiment of the present invention;

FIG. 2 is a plan view of an airbag cushion in the passenger airbag apparatus according to the first exemplary embodiment of the present invention;

FIG. 3 is a cross-sectional view taken along the line A-A of FIG. 2;

FIGS. 4 and 5 are views illustrating the operation of the passenger airbag apparatus according to the first exemplary embodiment of the present invention;

FIG. 6 is a plan view of an airbag cushion in a passenger airbag apparatus according to a second exemplary embodiment of the present invention;

FIG. 7 is a cross-sectional view taken along the line B-B of FIG. 6;

FIG. 8 is a view showing a process of making a folded portion in the passenger airbag apparatus according to the second exemplary embodiment of the present invention;

FIG. 9 is a plan view of an airbag cushion in a passenger airbag apparatus according to a third exemplary embodiment of the present invention; and

FIG. 10 is a cross-sectional view taken along line C-C of FIG. 9.

### DETAILED DESCRIPTION OF THE EMBODIMENTS

Advantages and features of the present invention and methods for achieving them will be made clear from exemplary embodiments described below in detail with reference to the accompanying drawings. However, the present invention is not limited to exemplary embodiments described herein and will be implemented in various forms. The exemplary embodiments are provided by way of example only so that a person of ordinary skill in the art can fully understand the disclosures of the present invention and the scope of the present invention. Therefore, the present invention will be defined only by the scope of the appended claims. Like reference numerals designate like components throughout the specification.

Hereinafter, the present invention is described with reference to the drawings illustrating passenger airbag apparatuses according to exemplary embodiments of the present invention.

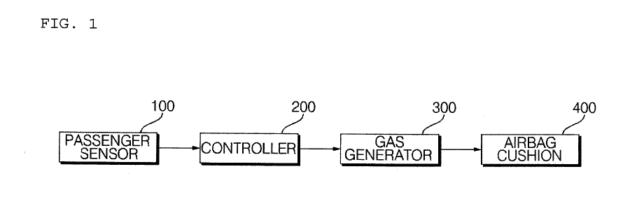

FIG. 1 is a block diagram of a passenger airbag apparatus according to a first exemplary embodiment of the present invention.

Referring to FIG. 1, a passenger airbag apparatus according to the first exemplary embodiment of the present invention includes a passenger sensor 100, a controller 200, a gas generator 300, and an airbag cushion 400.

The passenger sensor 100 detects information on the ‘type of a passenger’ and the ‘position of a passenger’ in the passenger seat and transmits the information to the controller 200.

The ‘type of a passenger’ implies the types classified as an adult, an infant, and a child, in consideration of the passenger's body conditions. Since many countries prescribe that only adults are allowed to drive a vehicle, only adults can sit in the driver seat; however, not only adults, but infants, children, and adults with poor body conditions, even if they are adult, sit in the passenger seat. In particular, passengers who sit in the passenger seat are strictly classified into adults, infants of one and under, infants of three and under, children of six and under, and 5% women with poor body conditions in the whole women in North America, such that all of them is not hurt by the unfolding pressure of the airbag cushion 400, such that the ‘type of a passenger’ includes all of them.

The passenger sensor 100 includes a weight sensor that is mounted in the passenger seat and senses the weight of passengers to discriminate the types of the passengers in the passenger seat such that the unfolding pressure of the airbag cushion 400 can change in accordance with the types of the passengers in the passenger seat.

Further, the ‘position of a passenger’ implies the distance from the passengers in the passenger seat to the airbag cushion 400. That is, passengers may sit at the front portion or the rear portion of the passenger seat, in which the distance between the passengers in the passenger seat and the airbag cushion 400 may change. Further, passengers may adjust the position of the passenger seat forward/backward to fit their body conditions, in which the distance between the passengers in the passenger seat and the airbag cushion 400 may also change. Hereinafter, it is exemplified only when a passenger is positioned at the front portion or the rear portion of the passenger seat.

When a passenger sits at the front portion of the passenger seat, the distance between the airbag cushion 400 and the passenger is small, such that the passenger may be hurt by the excessive unfolding pressure of the airbag cushion 400.

Further, when a passenger sits at the rear portion of the passenger seat, the distance between the airbag cushion 400 and the passenger is large, such that the airbag cushion 400 may fail to protect the passenger with sufficient unfolding pressure.

Therefore, the passenger sensor 100 also includes a position sensor that can sense the position of a passenger in the passenger seat to change the unfolding pressure of the airbag cushion 400 in accordance with the position of the passenger in the passenger seat.

The controller 200 can discriminate the passengers in the passenger seat into an adult, an infant, a child, and an adult with poor body conditions, from the information supplied from the passenger sensor 100, and can also recognize where the passengers is positioned in the passenger seat.

The controller 200 recognizes the type and position of a passenger in the passenger seat and then outputs a control signal to control the gas generator 300.

The gas generator 300 generates different amounts of gas in response to the control signal from the controller 200.

In general, an inflator is used for the gas generating unit that supplies a gas into the airbag cushion 400. That is, the inflator accommodates a gas generating unit and the gas generating unit explodes in response to the control signal from the controller 200, thereby generating a gas.

The gas generator 300 may be composed of a plurality of inflators that generates different gases by including a different capacity of gas generating units, or may be implemented by one inflator that has a plurality of spaces for the gas generating units and includes a different capacity of gas generating units in the spaces. Hereinafter, for the convenience of description, it is exemplified that the gas generator 300 is composed of a low-capacity inflator that generates a small amount of gas and a high-capacity inflator that generates a larger amount of gas than the low-capacity inflator.

The low-capacity inflator and/or the high-capacity inflator operate in response to the control signal from the controller 200, such that the gas generator 300 can generate different amounts of gas.

The gas generator 300 is connected with the airbag cushion 400 and provides a gas to the airbag cushion 400 and the airbag cushion 400 protects a passenger in the passenger seat while unfolding and inflating by means of the gas provided from the gas generator 300. Since the low-capacity inflator and/or the high-capacity inflator operates in response to the control signal from the controller 200, the airbag cushion 400 inflates in different sizes in accordance with the type and position of the passenger in the passenger seat, such that it can protect the passenger in the passenger seat with different unfolding pressures in accordance with the type and position of the passenger in the passenger seat.

The airbag cushion 400 inflates in different sizes, depending on the amount of gas that is provided from the gas generator 300, to protect the passenger in the passenger seat with different unfolding pressure in accordance with the type and position of the passenger in this exemplary embodiment, and the airbag cushion 400 is described in detail below.

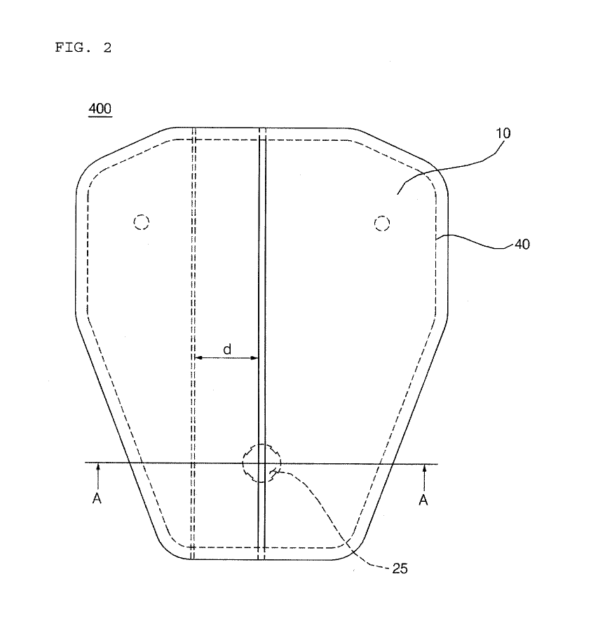

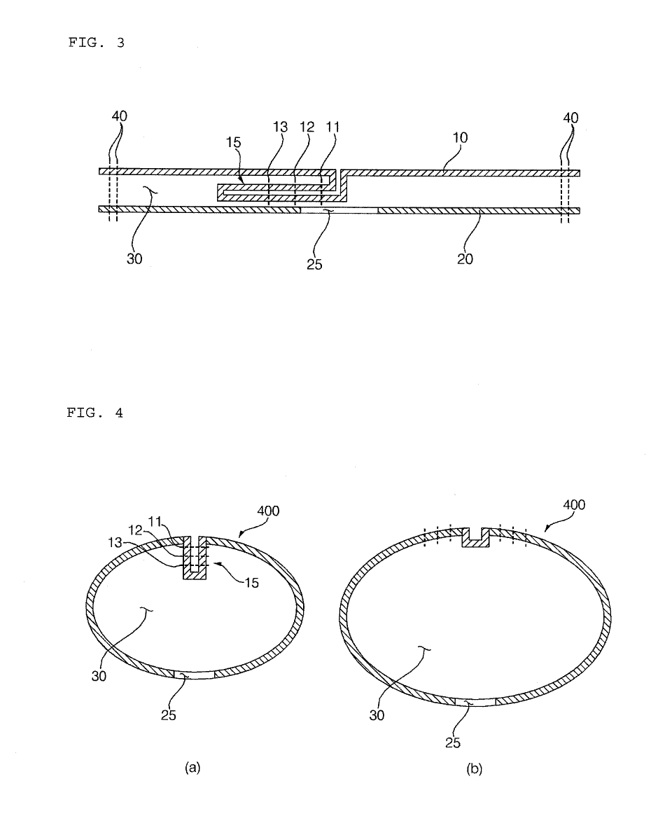

FIG. 2 is a plan view of the airbag cushion 400 in the passenger airbag apparatus according to the first exemplary embodiment of the present invention and FIG. 3 is a cross-sectional view taken along the line A-A of FIG. 2.

Referring to FIGS. 2 and 3, the airbag cushion 400 of the passenger airbag apparatus according to the first exemplary embodiment of the present invention includes a first panel 10 that contacts with a passenger in the passenger seat while inflating and a second panel 200 that forms a chamber 30 in which a gas flows, together with the first panel 10 by being combined with the first panel 10.

The first panel 10 and the second panel 20 are combined by sewing the edges 40, such that the chamber 30 that stores a gas is defined therein.

The second panel 20 has a gas inlet hole 25 connected with the gas generator 300 and is connected with the gas generator 300 such that the gas generated from the gas generator 300 can flow into the chamber 30 through the gas inlet hole 25. Therefore, the airbag cushion 400 protects a passenger while unfolding and inflating by means of the pressure of a gas, when the gas flows into the chamber 30 through the gas inlet hole 25 from the gas generator 300.

Meanwhile, the first panel 10 has a larger area of a portion for forming the chamber 30, than the second panel 20. Therefore, the first panel 10 has a spare area of the portion for forming the chamber 30, in comparison to the second panel 20. A folded portion 14 is formed in the first panel 10 by folding the spare area and making stitches 11, 12, and 13 such that the folded portion is not unfolded. Thereafter, the first panel 10 and the second panel 20 are combined flat by sewing the edges 40 of the first panel 10 and the second panel 20, such that the 2D airbag cushion 400 is completed.

As described above, since the passenger airbag cushion 400 is composed of two panels 10 and 20 and the 2D airbag cushion 400 is completed by combining the two panels 10 and 20 flat, a folding process of the complete airbag cushion 400 can be performed by a machine, such that the folding process of the passenger airbag cushion 400 can be automated. That is, since the existing airbag cushions are composed of three panels in 3D, not flat, the folding process for inserting the airbag cushions in the airbag housing has been performed by hand; however, since the passenger airbag cushion 400 according to an exemplary embodiment of the present invention is made flat in 2D, the folding process can be automatically performed by a machine.

Meanwhile, although it has been described in the above that the first panel 10 that contacts to a passenger when inflating has a larger area of the portion for forming the chamber 30 than the second pane and the folded portion 15 is formed, it may be possible that the second panel 20 has a larger area of the portion for forming the chamber 30 than the first panel 10 and the folded portion 15 is formed. Hereinafter, it is exemplified that the first panel 10 that contacts to a passenger when inflating has a larger area of the portion for forming the chamber 30 than the second panel 20, thereby forming the folded portion 15.

The edges of the first panel 10 and the second panel 20 are sewn, with the folded portion 15 facing the second panel 20. Therefore, the folded portion 15 is disposed in the chamber 30, protruding toward the second panel 20.

The folded portion 40 is not necessarily disposed in the chamber 30 in the airbag cushion 400, in order for the airbag cushion 400 inflates in different size while the stitches 11, 12, and 13 of the folded portion 14 are torn, when a gas flows into the chamber 30 and the airbag cushion 400 inflates. That is, it may be possible to sewing the edges 40 of the first panel 10 and the second panel 20, with the folded portion 15 outside, after disposing the folded portion 40 outside the airbag cushion 400, when sewing the edges 40 of the first panel 10 and the second panel 20.

The folded portion 15 is disposed in the chamber 30, with the center of the first panel 10 folded. The folded portion 15 is folded to a side with respect to the gas inlet hole 25 in the chamber 30.

The folded portion 15 is continuously formed from a upper portion to a lower portion of the first panel 10, such that the upper end of the folded portion 15 is connected to a upper portion of the second panel 20 and the lower end is connected to a lower portion of the second panel 20, when the edges of the first panel 10 and the second panel 20 are sewn. As described above, since the upper end of the folded portion 15 is connected to the upper portion of the second panel 20 and the lower end is connected to the lower portion of the second panel 20, the folded portion 14 pulls the upper portion and the lower portion of the airbag cushion 400 while unfolding by means of the gas flowing into the chamber 30, such that the upper portion and the lower portion of the airbag cushion 400 are depressed inside, and accordingly, it is possible to prevent a passenger in the passenger seat from being hurt by excessive folding pressure of the airbag cushion 400. This is described below with reference to FIG. 5.

Further, the folded portion 15 is formed with a constant width d from the upper portion to the lower portion. Obviously, the folded portion 15 may be formed with the width d increasing or decreasing from the upper portion to the lower portion, depending on the width of the airbag cushion 400. For example, when the upper portion is larger in width than the lower portion in the airbag cushion 400, the folded portion 15 may be formed with the width d increasing from the upper portion to the lower portion. On the contrary, when the lower portion is larger in width than the upper portion in the airbag cushion 400, the folded portion 15 may be formed with the width d decreasing from the upper portion to the lower portion.

The folded portion 15 is unfolded while the stitches 11, 12, and 13 are torn by the amount of gas supplied into the chamber 30 from the gas generator 300. Therefore, the folded portion 15 is unfolded in different amount in accordance with the amount of gas generated from the gas generator 300, such that the airbag cushion 400 inflates in different sizes. Although this exemplary embodiment has exemplified when three stitches 11, 12, and 13 are formed, the stitches is not necessarily three, but at least one or more is sufficient, in order for the airbag cushion 400 to inflate in different sizes in accordance with the amount of gas provided from the gas generator 300.

As described above, the folded portion 15 is the portion that is unfolded while the stitches 11, 12, and 13 are torn by the amount of gas supplied into the chamber 30 from the gas generator 300. That is, the gas generator 300 generates and supplies different amounts of gas into the chamber 30 of the airbag cushion 400 by the low-capacity inflator and/or the high-capacity inflator that operates in accordance with the type and position of a passenger in the passenger seat, in which the inflation force of the airbag cushion 400 depends on the amount of gas supplied in to the chamber 30 and the folded portion 15 is unfolded by the inflation force of the airbag cushion 400 while the stitches 11, 12, and 13 are torn, such that the airbag cushion 400 can inflate in different sizes.

For example, when determining that the passenger in the passenger seat is an infant, the controller 200 operates only the low-capacity inflator such that the gas generator 300 generates a small amount of gas, and the amount of gas provided to the airbag cushion 400 is small, such that the inflation force of the airbag cushion 400 is small and stitches 11, 12, and 13 may not be torn; therefore, the airbag cushion 400 can inflate in a small size. Further, when determining that the passenger in the passenger seat is a child with superior body conditions more than an infant, the controller 200 operates only the high-capacity inflator such that the gas generator 300 generates a larger amount of gas that the above case, and the amount of gas provided to the airbag cushion 400 is larger than the above case, such that the inflation force of the airbag cushion 400 is larger than the above case and some of stitches 11, 12, and 13 can be torn; therefore, the airbag cushion 400 can inflate in a larger size than the above case. Further, when determining that the passenger in the passenger seat is an adult with superior body conditions more than a child, the controller 200 simultaneously operates the low-capacity inflator and the high-capacity inflator such that the gas generator 300 generates a larger amount of gas that the above cases, and the amount of gas provided to the airbag cushion 400 is larger than the above cases, such that the inflation force of the airbag cushion 400 is larger than the above cases and all of stitches 11, 12, and 13 may be torn; therefore, the airbag cushion 400 can inflate in a larger size than the above cases. Although the types of passengers are classified into only an infant, a child, and an adult in this exemplary embodiment, it is just an example and it is obviously possible to provide a different amounts of gas into the airbag cushion 400, depending on the types of passengers, by classifying the types of passengers in more detail and providing the gas generator 300 with more inflators.

It has been exemplified in the above only when a different amounts of gas is generated from the gas generator 300 and provided to the airbag cushion 400 in accordance with the ‘type of a passenger’ in the passenger seat and the airbag cushion 400 inflates in different sizes while the folded portion 15 is unfolded, but it may be possible to unfold the folded portion 15 of the airbag cushion 400 in different sizes by making the gas generator 300 generate a different amounts of gas and providing the gas to the airbag cushion 400, in accordance with the ‘position of a passenger’ too. That is, when determining that a passenger sits at the front portion of the passenger seat, the controller 200 operates only the low-capacity inflator such that the gas generator 300 generates a small amount of gas and the amount of gas provided to the airbag cushion 400 is small, such that the inflation force of the airbag cushion 400 is small and stitches 11, 12, and 13 may not be torn; therefore, the airbag cushion 400 can inflate in a small size. Further, when determining that the passenger sits at the rear portion of the passenger seat, the controller 200 operates only the high-capacity inflator such that the gas generator 300 generates a larger amount of gas that the above case and the amount of gas provided to the airbag cushion 400 is larger than the above case, such that the inflation force of the airbag cushion 400 is larger than the above case and the stitches 11, 12, and 13 can be torn; therefore, the airbag cushion 400 can inflate in a larger size than the above case.

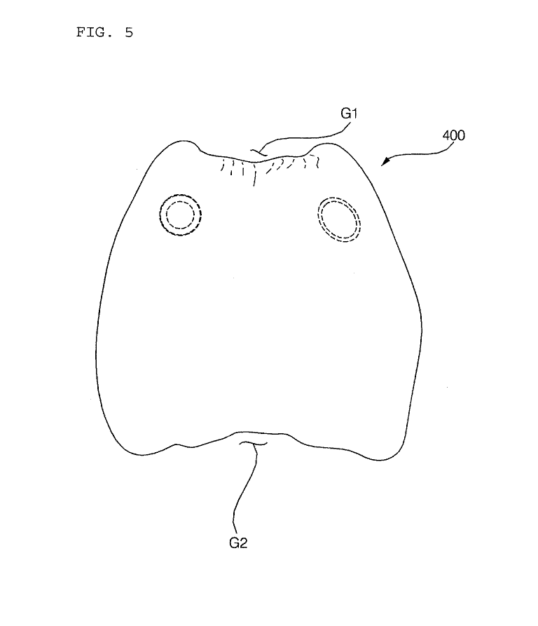

FIGS. 4 and 5 are views illustrating the operation of the passenger airbag apparatus according to the first exemplary embodiment of the present invention.

The operation of the passenger airbag apparatus having the above configuration according to the first exemplary embodiment is described below.

First, the passenger sensor 100 detects information on the type and position of a passenger in the passenger seat and transmits the information to the controller 200 and the controller 200 determines the type and position of the passenger in the passenger seat on the basis of the information from the passenger sensor 100.

When a car accident occurs under those conditions, the controller 200 controls the gas generator 300 to generate different amounts of gas by outputting different control signals for the determined type and position of the passenger.

Thereafter, the gas generated from the gas generator 300 is supplied into the chamber 30 of the airbag cushion 400 through the gas inlet hole 25 and the airbag cushion 400 starts to inflate by means of the gas supplied from the gas generator 300.

In this process, if the amount of gas supplied from the gas generator 300 is small, the stitches 11, 12, and 13 of the folded portion 15 are not torn, such that the airbag cushion 400 inflates in a small size, as shown in FIG. 4A. Further, if the amount of gas supplied from the gas generator 300 is large, some or all of the stitches 11, 12, and 13 of the folded portion 15 are torn, such that the airbag cushion 400 inflates in a large size, as shown in FIG. 4B. FIG. 4B exemplifies when all the stitches 11, 12, and 13 have been torn.

Meanwhile, since the upper end of the folded portion 15 is connected to the upper portion of the second panel 20 and the lower end is connected to the lower portion of the second panel 20, the folded portion 15 pulls the upper and lower portions of the first panel 10 and the second panel 20, when the folded portion 15 is unfolded while the airbag cushion 400 inflates.

Therefore, when the airbag cushion 400 has finished unfolding, grooves G1 and G2 depressed inside are formed at the upper portion and the lower portion of the airbag cushion 400, as shown in FIG. 5, such that the passenger in the passenger seat is prevented from being hurt by excessive unfolding pressure of the airbag cushion 400. For example, since infants are usually laid with the heads forward in a child restraint system mounted on the passenger seat, the heads are inserted in the groove G2 when the airbag cushion 400 has inflated, such that it is possible to prevent the infants from being pressed by the inflating airbag cushion 400. Further, for children or adults with poor body conditions, the heads are inserted in the groove G1 when the airbag cushion 400 has inflated, it is possible to prevent the children or the adult with poor body conditions from being hurt by excessive unfolding pressure of the airbag cushion 400.

Further, since it is possible to increase the size of the chamber 300 when the passenger airbag cushion 400 has inflated, using the folded portion 15, it is possible to achieve performance equivalent to the size of the chamber of the 3D passenger airbag cushion composed of three panels in the related art, by using only two panels 10 and 20.

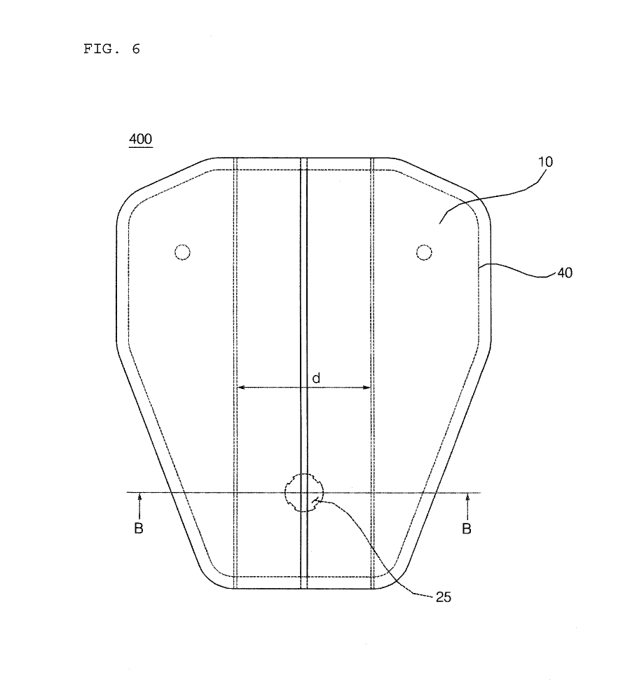

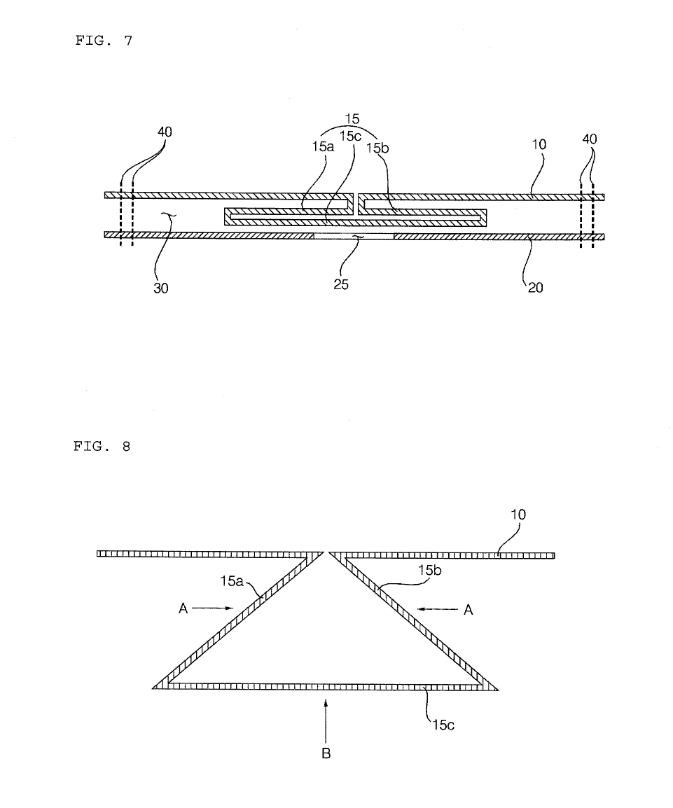

FIG. 6 is a plan view of an airbag cushion in a passenger airbag apparatus according to a second exemplary embodiment of the present invention and FIG. 7 is a cross-sectional view taken along the line B-B of FIG. 6. The same components as those in the exemplary embodiment described above are given the same reference numerals and the detailed description is not provided.

Referring to FIGS. 6 and 7, it can be seen that the passenger airbag apparatus according to the second exemplary embodiment of the present invention is different from the exemplary embodiment described above.

That is, although the folded portion 15 has been folded to a side with respect to the gas inlet hole 25 in the exemplary embodiment described above, the folded portion 15 are folded to both sides with respect to the gas inlet hole 25 in this exemplary embodiment.

In detail, the folded portion 15 has a first folded portion 15a folded to a side with respect to the gas inlet hole 25, a second folded portion 15b folded to the other side with respect to the gas inlet hole 25, and a connecting portion 15c connecting the first folded portion 15a with the second folded portion 15b.

The first folded portion 15a and the second folded portion 15b are folded symmetrically in the same size to the left and right with respect to a center of the connecting portion 15c.

The area of the folded portion 15 of the passenger airbag apparatus according to the second exemplary embodiment of the present invention is larger than that of the exemplary embodiment described above, such that it is possible to inflate the airbag cushion 400 in a larger size.

FIG. 8 is a view showing a process of making the folded portion 15 in the passenger airbag apparatus according to the second exemplary embodiment of the present invention.

Referring to FIG. 8, the first folded portion 15a, the second folded portion 15b, and the connecting portion 15c are formed by pressing both sides of the portion having a spare area in comparison to the second panel 20, in the portion for forming the chamber 30 of the first panel 10, in the direction A, and then pressing the lower end in the direction B.

Thereafter, the first panel 10 and the second panel 20 are overlapped flat, with the folded portion 15 and the second panel 20 facing each other, the edges 40 of the first panel 10 and the second panel 20 are sewn and the upper and lower ends of the folded portion 15 are sewn to the edge 40 of the second panel 20, as shown in FIGS. 6 and 7, thereby completing the passenger airbag cushion 400.

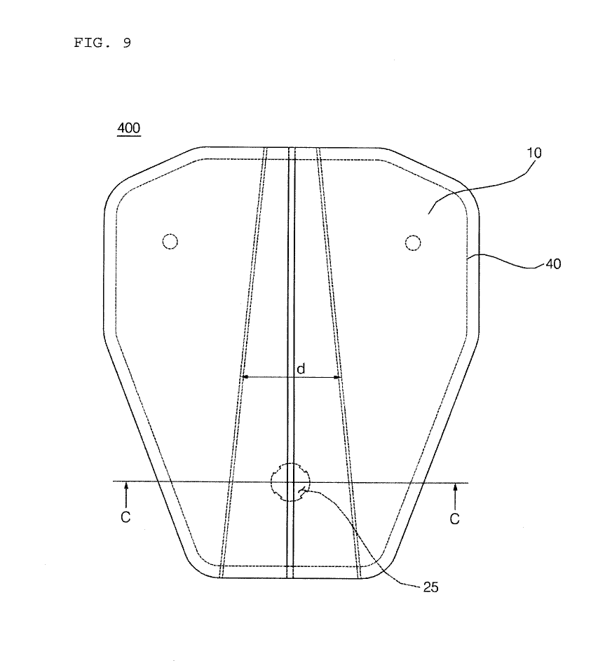

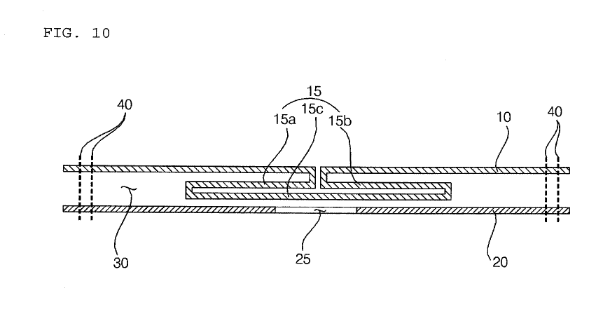

FIG. 9 is a plan view of an airbag cushion in a passenger airbag apparatus according to a third exemplary embodiment of the present invention and FIG. 10 is a cross-sectional view taken along the line C-C of FIG. 9. The same components as those in the exemplary embodiments described above are given the same reference numerals and the detailed description is not provided.

Referring to FIGS. 9 and 10, it can be seen that the passenger airbag apparatus according to the third exemplary embodiment is different from the exemplary embodiments described above.

That is, although the folded portions 15 are formed with constant widths d from the upper portion to the lower portion in the exemplary embodiments described above, the folded portion 15 is formed with the width d increasing from the upper portion to the lower portion in this exemplary embodiment.

In the passenger airbag apparatus according to the third exemplary embodiment of the present invention, the area of the upper portion of the folded portion 15 is smaller and the area of the lower portion is larger than those of the exemplary embodiments described above, such that the upper portion inflates small and the lower portion inflates large when the airbag cushion 400 inflates. That is, the upper portion is the face protection portion that contacts with the passenger's face and the lower portion is the chest protection portion that contacts with the passenger's chest, in the airbag cushion 400 that has inflated, in which the upper portion of the airbag cushion 400 can protect the passenger's face with appropriated unfolding pressure by inflating small and the lower portion can protect the passenger's chest with appropriate unfolding pressure by inflating large.

As described above, since the folded portion 15 that is inflated by the amount of gas supplied from the gas generator 300 is formed in the airbag cushion 400, the passenger airbag apparatus according to an embodiment of the present invention can allow the airbag cushion 400 to inflate in different sizes in accordance with the types and positions of the passengers in the passenger seat.

Further, since the airbag cushion 400 is composed of two panels 10 and 20 combined flat, the folding process can be automated.

It will be understood to those skilled in the art that the present invention may be implemented in various ways without changing the spirit of necessary features of the present invention. Accordingly, the embodiments described above are provided as examples in the whole respects and do not limit the present invention. The scope of the present invention is defined in the following claims and all changed or modified types derived from the meanings and scope of the claims and the equivalent concept thereof should be construed as being included in the scope of the present invention.

What is claimed is:

1. A passenger airbag apparatus, comprising:
a passenger sensor detecting information on the type and position of a passenger in a passenger seat;
a controller outputting control signal on the basis of the information supplied from the passenger sensor;
a gas generator generating different amounts of gas in response to the control signal transmitted from the controller; and
an airbag cushion connected with the gas generator, having a folded portion that is folded and bound, and inflating in different sizes while the folded portion is unfolded in accordance with the amounts of gas supplied from the gas generator.

2. The passenger airbag apparatus according to claim 1, wherein the airbag cushion includes:
a first panel having the folded portion; and
a second panel combined with the first panel to define a chamber in which the gas flows, and connected with the gas generator.

3. The passenger airbag apparatus according to claim 2, wherein the first panel has a spare area in comparison to the second panel by having a portion for forming the chamber larger than the second panel, and
the folded portion is formed by folding the spare area, such that the first panel and the second panel are combined flat.

4. The passenger airbag apparatus according to claim 2, wherein the folded portion is disposed in the chamber.

5. The passenger airbag apparatus according to claim 2, wherein the folded portion is formed continuously from a upper portion to a lower portion of the first panel, with one end connected to a upper portion of the second panel and the other end connected to a lower portion of the second panel.

6. The passenger airbag apparatus according to claim 5, wherein the second panel has a gas inlet hole connected with the gas generator, and
the folded portion is folded to a side with respect to the gas inlet hole.

7. The passenger airbag apparatus according to claim 5, wherein the second panel has a gas inlet hole connected with the gas generator, and
the folded portion has a first folded portion folded to a side with respect to the gas inlet hole, a second folded portion folded to the other side with respect to the gas inlet hole, and a connecting portion connecting the first folded portion with the second folded portion.

8. The passenger airbag apparatus according to claim 7, wherein the first folded portion and the second folded portion are symmetrically folded with respect to a center of the connecting portion.

9. The passenger airbag apparatus according to claim 5, wherein the folded portion is folded with a constant width from the upper portion to the lower portion.

10. The passenger airbag apparatus according to claim 5, wherein the folded portion is folded with the width increasing from the upper portion to the lower portion.

11. The passenger airbag apparatus according to claim 5, wherein as the gas flows into the chamber, the folded portion pulls the upper and lower portions of the first panel and the second panel while unfolding, such that the airbag cushion is depressed inside at the upper and lower portions and grooves are formed.

12. The passenger airbag apparatus according to claim 1, wherein the folded portion has at least one stitch that is torn by inflation force of the airbag cushion.
